(19) United States
(12) Patent Application Publication
(10) Pub. No.: US 2024/0152588 A1
(43) Pub. Date: May 9, 2024

(54) VOICE SIGNATURE FOR SECURE ORDER PICKUP

(71) Applicant: Toshiba Global Commerce Solutions, Inc., Durham, NC (US)

(72) Inventor: Julia Ann Patten, Youngsville, NC (US)

(21) Appl. No.: 18/053,914

(22) Filed: Nov. 9, 2022

(51) Int. Cl. G06F 21/32; G06Q 10/08; G06Q 20/20

(52) U.S. Cl. CPC G06F 21/32; G06Q 10/0836; G06Q 20/206

(57) ABSTRACT

Disclosed herein are systems and methods for associating a voice signature with an order identifier and/or authenticating an individual for an order pickup. A system can receive an order identifier and obtain an audio stream from a user that is designated to retrieve the contents of the order from a pickup location. The system can determine a voice signature associated with the audio stream and associate that voice signature with the order for pickup. During an order pickup period, an individual can provide an audio sample to the system to authenticate himself for picking up an order. The system can compare a voice signature of the audio sample with stored voice signatures relating to outstanding orders to determine whether the individual is authorized to retrieve an order identifier.

### BACKGROUND

The opportunity to buy items online or over-the-phone and pick up purchases at brick-and-mortar locations has created challenges relating to authenticating users at order pickup.

### DESCRIPTION OF THE FIGURES

FIG. 1 illustrates some embodiments of an order management environment for implementing secure order pickup using voice authentication.

FIG. 2 is a diagram illustrating an example of training a machine learning model in connection with the present disclosure.

FIG. 3 is a diagram illustrating an example of applying a trained machine learning model to a new observation associated with characterizing an audio signal or biometric data.

FIG. 4 is a flow diagram illustrative of an embodiment of an automated process for associating a voice signature with an order identifier.

FIG. 5 is a flow diagram illustrative of an embodiment of an automated process for authenticating an individual for order pickup.

Various embodiments are depicted in the accompanying drawings for illustrative purposes and should in no way be interpreted as limiting the scope of the embodiments. Furthermore, various features of different disclosed embodiments can be combined to form additional embodiments, which are part of this disclosure.

### DETAILED DESCRIPTION

The present application relates to authenticated order pickups. It will be appreciated that a customer may electronically place an order (e.g., from a retail store) and may designate herself or another individual to pick up the contents of the order from a designated pickup location. In the present disclosure, reference is made to a “user.” As used herein, the term “user” is used broadly to define any individual authorized (explicitly or implicitly) by the customer to pick up the order. Accordingly, in some cases, the user includes the customer, while in other cases the user includes another individual, such as a family member, friends, coworker, or the like.

In the present disclosure, reference is made to a “voice signature.” As used herein, the term “voice signature” is used broadly to define any voice feature that may characterize a voice of an individual. For example, a voice signature can include a distinctive pattern, frequency, duration, amplitude, volume, pitch, or the like of an individual's voice. In some cases, a voice signature uniquely identifies a voice from some or all other voices. In this way, a voice signature analysis can be utilized to identify an identity of a speaker.

### Overview

Often, when an order is placed online, data such as a customer identifier, a phone number, or an order identifier is collected, with the intention that this information be used to verify the customer's identity when picking up items at a retail store. However, with online orders, the number of orders is often voluminous and thus this “buy online, pickup in store” area of commerce is fraught with opportunities for erroneous order pickups, whether intentional or unintentional. For example, an employee, presented with an ID or other documentation, may not have the time or know-how to properly verify the validity of the document. Data privacy concerns also arise in instances where the customer is required to share personal data.

To address these or other concerns, disclosed herein is an order management system for enabling an efficient and secure order pickup process. An order management system in accordance with some embodiments of the present inventive concept uses voice authentication to verify whether a particular individual is authorized to retrieve an order identifier that is ready for pickup. In particular, during an order placement period, the order management system obtains an audio stream (sometimes including an authentication phrase) and associates a voice signature of the audio stream with the corresponding order identifier. During order pickup period, the system captures a phrase and parses the phrase for a recognized voice signature. The order management system can automatedly determine which order (if any) a particular user is authorized to retrieve and/or whether a particular user is authorized to retrieve a particular order. If a user provides a voice sample that matches a voice signature for a particular order identifier, the system can authenticate the user to retrieve the particular order identifier. In this way, the system advantageously improves the efficiency and security of the order pickup process.

The order management system can implement a machine learning system to apply a rigorous and automated process to identify a voice signature accurately and efficiently. The machine learning system can enable recognition and/or identification of tens, hundreds, thousands, or millions of voice signatures for tens, hundreds, thousands, or millions of users, thereby increasing accuracy and consistency, and reducing delay associated with the relative resources (e.g., computing or human) required to be allocated for tens, hundreds, or thousands of operators to manually verify the identity of users using picture ID, receipts, etc.

In light of the description herein, it will be understood that the embodiments disclosed herein substantially improve the ease and security of order pickup using voice authentication. The order management system improves the process of order pickup by enabling automated analysis of audio streams to determine whether an individual is authorized to retrieve the contents of an order from a pickup location. The ability to authenticate the individual using audio captured from the individual at a pickup location advantageously improves security related to order pickup, which improves the usage of facilities; and reduces the number of receipts or IDs for manual inspection, which improves the usage of labor, reduces processing time, and increases accuracies.

Thus, the presently disclosed embodiments represent an improvement at least in secure order pickup. Moreover, the presently disclosed embodiments address technical problems inherent within order pickup. These technical problems are addressed by the various technical solutions described herein, including obtaining an audio stream from a user during an order placement period, identifying a voice signature for the user, capturing a audio stream from an individual during an order placement period, determining that the individual is authorized to pick up contents of the order based on a determination that the second audio stream corresponds to the voice signature, etc. Thus, the present application represents a substantial improvement on existing order pickup systems in general.

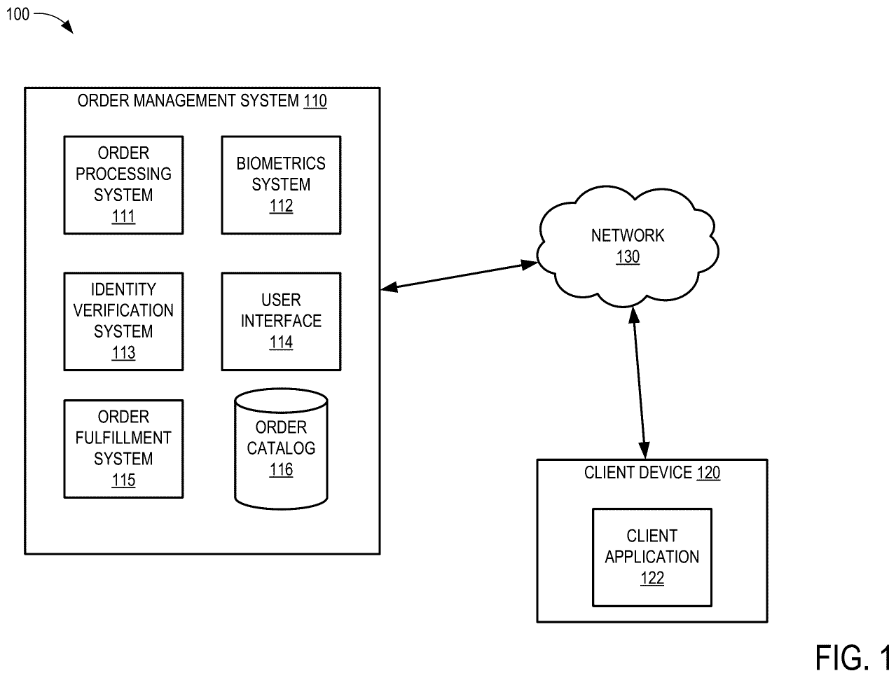

FIG. 1 illustrates some embodiments of an order management environment 100 for implementing secure order pickup using voice authentication. The order management environment 100 includes an order management system 110, a client device 120, and a network 130. In the illustrated embodiment, the order management system 110 includes an order processing system 111, a biometrics system 112, an identity verification system 113, a user interface 114, an order fulfillment system 115, and an order catalog 116. To simplify discussion and not to limit the present disclosure, FIG. 1 illustrates only one order management system 110, order processing system 111, biometrics system 112, identity verification system 113, user interface 114, order fulfillment system 115, and client device 120, though multiple may be used.

Any of the foregoing components or systems of the order management environment 100 may communicate via the network 130. Although only one network 130 is illustrated, multiple distinct and/or distributed networks 140 may exist. The network 130 can include any type of communication network. For example, the network 130 can include one or more of a wide area network (WAN), a local area network (LAN), a cellular network, an ad hoc network, a satellite network, a wired network, a wireless network, and so forth. In some embodiments, the network 130 can include the Internet.

Any of the foregoing components or systems of the order management environment 100, such as any combination of the order management system 110, the order processing system 111, the biometrics system 112, the identity verification system 113, the user interface 114, the order fulfillment system 115, or the client device 120 may be implemented using individual computing devices, processors, distributed processing systems, servers, isolated execution environments (e.g., virtual machines, containers, etc.), shared computing resources, or so on. Furthermore, any of the foregoing components or systems of the order management environment 100 may host or execute one or more client applications (e.g., client application 122), which may include a web browser, a mobile application, a background process that performs various operations with or without direct interaction from a user, or a “plug-in” or “extension” to another application, such as a web browser plug-in or extension.

The order management system 110 can facilitate secure order pickup using biometrics recognition techniques. Although embodiments herein generally described voice authentication, it will be appreciated that the techniques described herein are applicable to other biometrics as well. For example, biometrics data can include, but is not limited to, fingerprints, facial, iris, and palm or finger vein patterns.

The order management system 110 may include hardware and software components for establishing communications over the network 130. The order management system 110 may have varied local computing resources such as central processing units and architectures, memory, mass storage, graphics processing units, communication network availability and bandwidth, and so forth. Further, the order management system 110 may include any type of computing system. For example, the order management system 110 may include any type of computing device(s), such as desktops, laptops, and wireless mobile devices (for example, smart phones, PDAs, tablets, or the like), to name a few. The implementation of the order management system 110 may vary across embodiments. For example, in some cases, one or more components of the order management system 110 may be implemented as a portable or handheld device. As another example, in some cases, one or more components of the order management system 110 may be implemented as a fixed platform or a device that is fixed in a particular location.

Although reference is made throughout the specification to the order management system 110 performing various analytical or processing functions, it will be understood that, in some embodiments, other systems may perform one or more of these functions. In such embodiments, the order management system 110 can receive notifications of processing functions performed by the other systems, such as indications of the processing completion. Accordingly, in some embodiments, the amount of processing performed by the order management system 110 can be reduced and/or minimized, and the order management system 110 can act as a conduit to the other systems.

The order processing system 111 can receive order identifiers and communicate order data to an order fulfillment system 115. In some cases, the order fulfillment system 115 can automatedly prepare at least a portion of the order. In some cases, the order fulfillment system 115 provides information to an operator (e.g., via user interface 114), who can prepare at least a portion of the order.

An order may be received by the order processing system 111 from any of a variety of sources, such as from a customer using a mobile order and/or pay software mobile application, from a customer using an online ordering method, from a cashier entering an order identifier locally at a store in response to oral instructions from a customer at an in-store counter or via a drive-thru ordering system, a customer entering an order identifier locally via an in-store self-service kiosk, and/or other source.

The order processing system 111 may include, or interface with, a web browser, a mobile application or “app,” a background process that performs various operations with or without direct interaction from a user, or a “plug-in” or “extension” to another application, such as a web browser plug-in or extension. In some cases, the order processing system 111 may be hosted or executed by one or more host devices (not shown), which may broadly include any number of computing devices and/or virtual machine instances. Examples of an order processing system 111 may include, without limitation, smart phones, point of sale systems, kiosks, tablet computers, handheld computers, wearable devices, laptop computers, desktop computers, servers, and so forth.

The biometrics system 112 can obtain biometrics data. For example, as described herein, the biometrics system 112 can obtain a voice sample from individuals during various ordering and order-pickup stages. In some cases, the biometrics system 112 can process the voice samples to identify voice signatures associated with the voice samples. The biometrics system 112 can store the biometrics data in the order catalog 116.

The order catalog 116 can store order data. In some embodiments, the order data can include an indication of the contents of an order. For example, the order data can include information such as a product's name, item number, description, pricing, quantity, or other order data. In some cases, the order catalog 116 includes a comprehensive or semi-comprehensive itemized list that details outstanding orders (e.g., orders that have not been picked up), fulfilled orders, orders ready for pickup, etc.

The order catalog 116 can store biometrics data. For example, as described herein, the biometrics data include voice signature data corresponding to users. The order catalog 116 can store correlations of the order data and biometrics data such that particular voice signatures and/or other biometrics data are correlated with order data. In this way, the order catalog 116 can be queried with voice signature data to identity a corresponding order identifier.

The order catalog 116 can be maintained (for example, populated, updated, etc.) by the order processing system 111 and/or the biometrics system 112. As mentioned, in some embodiments, the order processing system 111 and/or the biometrics system 112 and order catalog 116 can be separate or independent of the order management system 110. Alternatively, in some embodiments, the order processing system 111 and/or the biometrics system 112 and/or order catalog 116 are part of the same system. Furthermore, in some cases, the order catalog 116 can be separate from or included in, or part of, the order processing system 111 and/or the biometrics system 112. As described herein, a particular order identifier can be associated with various biometric data. The order identifiers can be implemented as alphanumeric identifiers or other identifiers that can be used to uniquely identify one order identifier from another order identifier stored in the order catalog 116. For example, each order identifier can correspond to a particular order identifier, and the associated biometric data can include data relating to the biometrics of the user assigned to retrieve the order. In some such cases, as described herein, the biometric data can be used to identify associated order identifiers.

The order processing system 111 and/or the biometrics system 112 can be used to manage, create, develop, or update data of the order catalog 116. For example, the order processing system 111 and/or the biometrics system 112 can maintain the order catalog 116 with order data and biometrics. The order processing system 111 and/or the biometrics system 112 can populate the order catalog 116 and/or update it over time. As order data changes, the order processing system 111 and/or the biometrics system 112 can update the order catalog 116. In this way, the order catalog 116 can retain an up-to-date database.

The order catalog 116 can include or be implemented as cloud storage, such as Amazon Simple Storage Service (S3), Elastic Block Storage (EBS) or CloudWatch, Google Cloud Storage, Microsoft Azure Storage, InfluxDB, etc. The order catalog 116 can be made up of one or more data stores storing data that has been received from components of the order management system 110 or the client device 120, or data that has been received directly into the order catalog 116. The order catalog 116 can be configured to provide high availability, highly resilient, low loss data storage. In some cases, to provide the high availability, highly resilient, low loss data storage, the order catalog 116 can store multiple copies of the data in the same and different geographic locations and across different types of data stores (for example, solid state, hard drive, tape, etc.). Further, as data is received at the order catalog 116 it can be automatically replicated multiple times according to a replication factor to different data stores across the same and/or different geographic locations.

The identity verification system 113 can be used to determine whether an individual is authorized to retrieve an order identifier. For example, the identity verification system 113 can communicate with the biometrics system 112 and/or the order catalog 116 to obtain biometrics data (e.g., voice signature data) and/or order data. Further, the identity verification system 113 can determine whether the voice sample corresponds to or matches a stored voice signature for a ready-for-pick-up order identifier. If the identity verification system 113 determines that the voice sample corresponds to a stored voice signature, the identity verification system 113 will authorize the individual to retrieve the associated order identifier. As a corollary, if the identity verification system 113 determines that the voice sample does not correspond to any stored voice signatures, the identity verification system 113 may not authorize the individual to retrieve any order identifiers. In some cases, if the identity verification system 113 determines that the voice sample does not correspond to any stored voice signatures, the identity verification system 113 may initiate a request for a manual review to determine whether the individual is authorized to retrieve an order identifier.

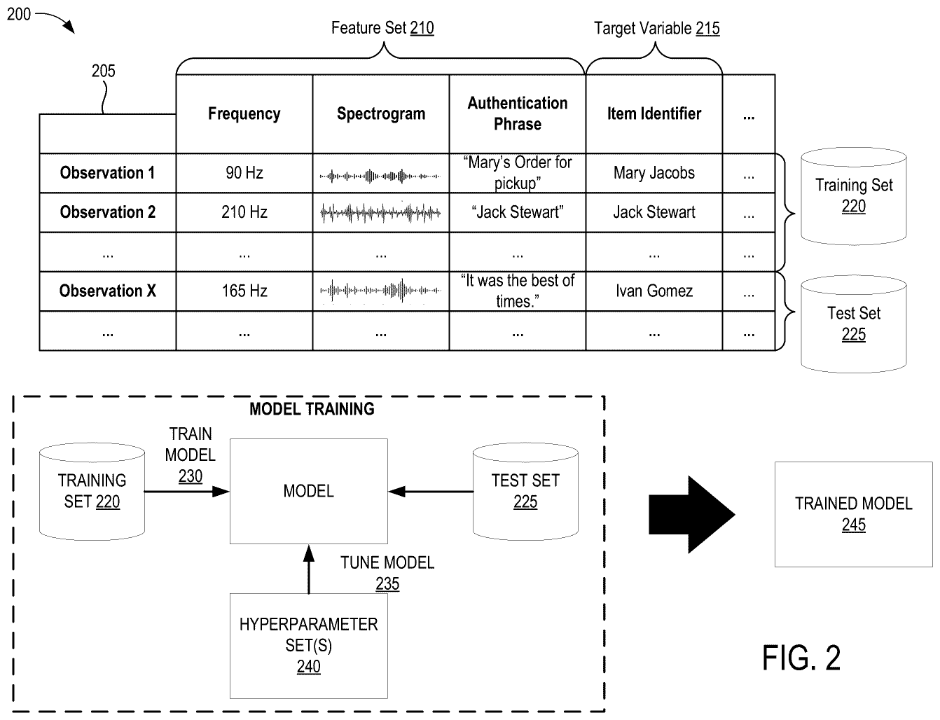

FIG. 2 is a diagram illustrating an example of training a machine learning model 200 in connection with the present disclosure. The machine learning model training described herein may be performed using a machine learning system. The machine learning system may include or may be included in a computing device, a server, a cloud computing environment, or the like, such as the order management system 110 of FIG. 1.

As shown by reference number 205, a machine learning model may be trained using a set of observations. The set of observations may be obtained and/or input from historical data, such as data gathered during one or more processes described herein. For example, the set of observations may include data gathered from the order management system 110, the biometrics system 112, the identity verification system, and/or the user interface 114, as described elsewhere herein. In some implementations, the machine learning system may receive the set of observations (e.g., as input) from the order management system 110, the biometrics system 112, the identity verification system, the user interface 114, or from a storage device (e.g., the order catalog 116). In some cases, the set of observations may include data gathered from the client device 120, as described elsewhere herein.

As shown by reference number 210, a feature set may be derived from the set of observations. The feature set may include a set of variables. A variable may be referred to as a feature. A specific observation may include a set of variable values corresponding to the set of variables. A set of variable values may be specific to an observation. In some cases, different observations may be associated with different sets of variable values, sometimes referred to as feature values.

In some implementations, the machine learning system may determine variables for a set of observations and/or variable values for a specific observation based on input received from the order management system 110. For example, the machine learning system may identify a feature set (e.g., one or more features and/or corresponding feature values) from structured data input to the machine learning system, such as by extracting data from a particular column of a table, extracting data from a particular field of a form and/or a message, and/or extracting data received in a structured data format. Additionally, or alternatively, the machine learning system may receive input from one or more systems of the order management system 110 or from an operator to determine features and/or feature values.

In some implementations, the machine learning system may perform natural language processing and/or another feature identification technique to extract features (e.g., variables) and/or feature values (e.g., variable values) from text (e.g., unstructured data) input to the machine learning system, such as by identifying keywords and/or values associated with those keywords from the text.

As an example, a feature set for a set of observations may include a first feature of Frequency, a second feature of Spectrogram, a third feature of Authentication Phrase, and so on. As shown, for a first observation, the first feature may have a value of “90 Hz”, the second feature may have a value of the respective spectrogram illustrated in FIG. 2, the third feature may have a value of “Mary's Order for pickup”, and so on. These features and feature values are provided as examples and may differ in other examples. For example, the feature set may include one or more of the following features: phonation, pitch, loudness, rate, sex, amplitude, timbre, rhythm, vowel sounds, consonant sounds, the length and emphasis of the individual sounds, acoustic features (e.g., Mel-Frequency Cepstral Coefficients (MFCC), the Perceptual Linear Prediction (PLP), the Deep Feature, the Power-Normalized Cepstral Coefficients (PNCC)), or features of an acoustic waveform. For example, in some cases, the machine learning system is text-dependent such that it uses system-prompted content (e.g., a predetermined authentication phrase) or content within an allowed range. As another example, in some cases, the machine learning system is text-independent in that it does not restrict the content spoken by the user. In some cases, the machine learning system is a hybrid, sometimes referred to as limited text-dependent such that it can collocate some numbers or symbols at random and require users to read the corresponding content to get the voiceprint recognized.

In some implementations, the machine learning system may pre-process and/or perform dimensionality reduction to reduce the feature set and/or combine features of the feature set to a minimum feature set. A machine learning model may be trained on the minimum feature set, thereby conserving resources of the machine learning system (e.g., processing resources and/or memory resources) used to train the machine learning model.

In some cases, the machine learning system can depict a speaker's voice features from different dimensions. Coupled with effective score normalization, voice features from different dimensions can be integrated to elevate the overall system performance.

The set of observations may be associated with a target variable 215. The target variable 215 may represent a variable having a numeric value (e.g., an integer value or a floating point value), may represent a variable having a numeric value that falls within a range of values or has some discrete possible values, may represent a variable that is selectable from one of multiple options (e.g., one of multiples classes, classifications, or labels), or may represent a variable having a Boolean value (e.g., 0 or 1, True or False, Yes or No, Male or Female), among other examples. A target variable may be associated with a target variable value, and a target variable value may be specific to an observation. In some cases, different observations may be associated with different target variable values. It will be understood that the target variable may vary across embodiments. For example, in some cases, the target variable 215 is a name or other identifier associated with a customer, order, or user.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set 210 that lead to a target variable value. A machine learning model that is trained to predict a target variable value may be referred to as a supervised learning model or a predictive model. When the target variable is associated with continuous target variable values (e.g., a range of numbers), the machine learning model may employ a regression technique. When the target variable is associated with categorical target variable values (e.g., classes or labels), the machine learning model may employ a classification technique.

In some implementations, the machine learning model may be trained on a set of observations that do not include a target variable (or that include a target variable, but the machine learning model is not being executed to predict the target variable). This may be referred to as an unsupervised learning model, an automated data analysis model, or an automated signal extraction model. In this case, the machine learning model may learn patterns from the set of observations without labeling or supervision, and may provide output that indicates such patterns, such as by using clustering and/or association to identify related groups of items within the set of observations.

As further shown, the machine learning system may partition the set of observations into a training set 220 that includes a first subset of observations of the set of observations, and a test set 225 that includes a second subset of observations of the set of observations. The training set 220 may be used to train (e.g., fit or tune) the machine learning model, while the test set 225 may be used to evaluate a machine learning model that is trained using the training set 220. For example, for supervised learning, the test set 225 may be used for initial model training using the first subset of observations, and the test set 225 may be used to test whether the trained model accurately predicts target variables in the second subset of observations. In some implementations, the machine learning system may partition the set of observations into the training set 220 and the test set 225 by including a first portion or a first percentage of the set of observations in the training set 220 (e.g., 75%, 80%, or 85%, among other examples) and including a second portion or a second percentage of the set of observations in the test set 225 (e.g., 25%, 20%, or 25%, among other examples). In some implementations, the machine learning system may randomly select observations to be included in the training set 220 and/or the test set 225.

As shown by reference number 230, the machine learning system may train a machine learning model using the training set 220. This training may include executing, by the machine learning system, a machine learning algorithm to determine a set of model parameters based on the training set 220. In some implementations, the machine learning algorithm may include a regression algorithm (e.g., linear regression or logistic regression), which may include a regularized regression algorithm (e.g., Lasso regression, Ridge regression, or Elastic-Net regression). Additionally, or alternatively, the machine learning algorithm may include a decision tree algorithm, which may include a tree ensemble algorithm (e.g., generated using bagging and/or boosting), a random forest algorithm, or a boosted trees algorithm. A model parameter may include an attribute of a machine learning model that is learned from data input into the model (e.g., the training set 220). For example, for a regression algorithm, a model parameter may include a regression coefficient (e.g., a weight). For a decision tree algorithm, a model parameter may include a decision tree split location, as an example.

As shown by reference number 235, the machine learning system may use one or more hyperparameter sets 240 to tune the machine learning model. A hyperparameter may include a structural parameter that controls execution of a machine learning algorithm by the machine learning system, such as a constraint applied to the machine learning algorithm. Unlike a model parameter, a hyperparameter is not learned from data input into the model. An example hyperparameter for a regularized regression algorithm includes a strength (e.g., a weight) of a penalty applied to a regression coefficient to mitigate overfitting of the machine learning model to the training set 220. The penalty may be applied based on a size of a coefficient value (e.g., for Lasso regression, such as to penalize large coefficient values), may be applied based on a squared size of a coefficient value (e.g., for Ridge regression, such as to penalize large squared coefficient values), may be applied based on a ratio of the size and the squared size (e.g., for Elastic-Net regression), and/or may be applied by setting one or more feature values to zero (e.g., for automatic feature selection). Example hyperparameters for a decision tree algorithm include a tree ensemble technique to be applied (e.g., bagging, boosting, a random forest algorithm, and/or a boosted trees algorithm), a number of features to evaluate, a number of observations to use, a maximum depth of each decision tree (e.g., a number of branches permitted for the decision tree), or a number of decision trees to include in a random forest algorithm.

To train a machine learning model, the machine learning system may identify a set of machine learning algorithms to be trained (e.g., based on operator input that identifies the one or more machine learning algorithms and/or based on random selection of a set of machine learning algorithms), and may train the set of machine learning algorithms (e.g., independently for each machine learning algorithm in the set) using the training set 220. The machine learning system may tune each machine learning algorithm using one or more hyperparameter sets 240 (e.g., based on operator input that identifies hyperparameter sets 240 to be used and/or based on randomly generating hyperparameter values). The machine learning system may train a particular machine learning model using a specific machine learning algorithm and a corresponding hyperparameter set 240. In some implementations, the machine learning system may train multiple machine learning models to generate a set of model parameters for each machine learning model, where each machine learning model corresponds to a different combination of a machine learning algorithm and a hyperparameter set 240 for that machine learning algorithm.

In some implementations, the machine learning system may perform cross-validation when training a machine learning model. Cross validation can be used to obtain a reliable estimate of machine learning model performance using only the training set 220, and without using the test set 225, such as by splitting the training set 220 into a number of groups (e.g., based on operator input that identifies the number of groups and/or based on randomly selecting a number of groups) and using those groups to estimate model performance. For example, using k-fold cross-validation, observations in the training set 220 may be split into k groups (e.g., in order or at random). For a training procedure, one group may be marked as a hold-out group, and the remaining groups may be marked as training groups. For the training procedure, the machine learning system may train a machine learning model on the training groups and then test the machine learning model on the hold-out group to generate a cross-validation score. The machine learning system may repeat this training procedure using different hold-out groups and different test groups to generate a cross-validation score for each training procedure. In some implementations, the machine learning system may independently train the machine learning model k times, with each individual group being used as a hold-out group once and being used as a training group k-1 times. The machine learning system may combine the cross-validation scores for each training procedure to generate an overall cross-validation score for the machine learning model. The overall cross-validation score may include, for example, an average cross-validation score (e.g., across all training procedures), a standard deviation across cross-validation scores, or a standard error across cross-validation scores.

In some implementations, the machine learning system may perform cross-validation when training a machine learning model by splitting the training set into a number of groups (e.g., based on operator input that identifies the number of groups and/or based on randomly selecting a number of groups). The machine learning system may perform multiple training procedures and may generate a cross-validation score for each training procedure. The machine learning system may generate an overall cross-validation score for each hyperparameter set 240 associated with a particular machine learning algorithm. The machine learning system may compare the overall cross-validation scores for different hyperparameter sets 240 associated with the particular machine learning algorithm and may select the hyperparameter set 240 with the best (e.g., highest accuracy, lowest error, or closest to a desired threshold) overall cross-validation score for training the machine learning model. The machine learning system may then train the machine learning model using the selected hyperparameter set 240, without cross-validation (e.g., using all of data in the training set 220 without any hold-out groups), to generate a single machine learning model for a particular machine learning algorithm. The machine learning system may then test this machine learning model using the test set 225 to generate a performance score, such as a mean squared error (e.g., for regression), a mean absolute error (e.g., for regression), or an area under receiver operating characteristic curve (e.g., for classification). If the machine learning model performs adequately (e.g., with a performance score that satisfies a threshold), then the machine learning system may store that machine learning model as a trained machine learning model 245 to be used to analyze new observations, as described below in connection with FIG. 2.

In some implementations, the machine learning system may perform cross-validation, as described above, for multiple machine learning algorithms (e.g., independently), such as a regularized regression algorithm, different types of regularized regression algorithms, a decision tree algorithm, or different types of decision tree algorithms. Based on performing cross-validation for multiple machine learning algorithms, the machine learning system may generate multiple machine learning models, where each machine learning model has the best overall cross-validation score for a corresponding machine learning algorithm. The machine learning system may then train each machine learning model using the training set 220 (e.g., without cross-validation), and may test each machine learning model using the test set 225 to generate a corresponding performance score for each machine learning model. The machine learning model may compare the performance scores for each machine learning model and may select the machine learning model with the best (e.g., highest accuracy, lowest error, or closest to a desired threshold) performance score as the trained machine learning model 245.

As indicated above, FIG. 2 is provided as an example. Other examples may differ from what is described in connection with FIG. 2. For example, the machine learning model may be trained using a different process than what is described in connection with FIG. 2. Additionally, or alternatively, the machine learning model may employ a different machine learning algorithm than what is described in connection with FIG. 2, such as a Bayesian estimation algorithm, a k-nearest neighbor algorithm, an a priori algorithm, a k-means algorithm, a support vector machine algorithm, a neural network algorithm (e.g., a convolutional neural network algorithm), a deep learning algorithm, and/or a voiceprint recognition algorithm.

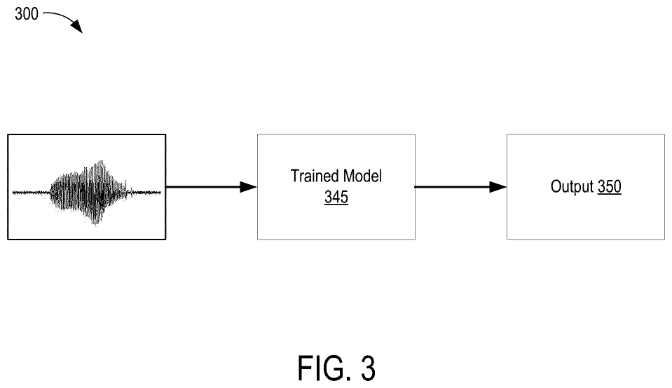

FIG. 3 is a diagram illustrating an example 300 of applying a trained machine learning model to a new observation associated with characterizing an audio signal or biometric data. The new observation may be input to a machine learning system that stores a trained machine learning model 345. In some implementations, the trained machine learning model 345 may be the trained machine learning model 245 described above in connection with FIG. 2. The machine learning system may include or may be included in a computing device, a server, or a cloud computing environment, such as the order management system 110 of FIG. 1.

As shown by reference number 210, the machine learning system may receive a new observation (or a set of new observations) and may input the new observation to the machine learning model 200. As described with respect to FIG. 2, the new observation may include, for example, a first feature of Frequency, a second feature of Spectrogram, a third feature of Authentication Phrase, a third feature of composition of item, and so on.

The machine learning system may apply the trained machine learning model 345 to the new observation to generate an output 350, such as a result indicating a name of an individual, or an indication of whether a voiceprint of an inputted audio signal matches a stored voiceprint. The type of output may depend on the type of machine learning model and/or the type of machine learning task being performed. For example, the output may include a predicted (e.g., estimated) value of target variable (e.g., a value within a continuous range of values, a discrete value, a label, a class, or a classification), such as when supervised learning is employed. Additionally, or alternatively, the output may include information that identifies a cluster to which the new observation belongs and/or information that indicates a degree of similarity between the new observation and one or more prior observations (e.g., which may have previously been new observations input to the machine learning model and/or observations used to train the machine learning model), such as when unsupervised learning is employed. In some implementations, the output 350 includes an indication of an identity of the speaker or an order identifier. For example, the output can correspond to a “best guess” for the order identifier, based on the input features. Furthermore, as described herein, in some cases, the output 350 includes a confidence value for the output.

In some implementations, the trained machine learning model 345 may predict a value of “Jack Stewart” and “96%” for the target variable for the new observation, indicating that there is a 96% likelihood that the individual speaking is “Jack Stewart.” Based on this prediction (e.g., based on the value having a particular label or classification or based on the value satisfying or failing to satisfy a threshold), the machine learning system may provide a recommendation and/or output for determination of a recommendation, such a recommendation to authenticate the individual to pick up Jack Stewart's order, among other examples. Additionally, or alternatively, the machine learning system may perform an automated action and/or may cause an automated action to be performed (e.g., by instructing another device to perform the automated action), such as causing a printer to print an indication of an order identifier or outputting an instruction to validate an order pickup.

As another example, if the machine learning system were to predict a value of “LOW” for the target variable of “confidence value”, then the machine learning system may provide a different recommendation and/or may perform or cause performance of a different automated action (e.g., output an indication to manually review). In some implementations, the recommendation and/or the automated action may be based on the target variable value having a particular label (e.g., classification or categorization) and/or may be based on whether the target variable value satisfies one or more threshold (e.g., whether the target variable value is greater than a threshold, is less than a threshold, is equal to a threshold, or falls within a range of threshold values).

In this way, the machine learning system may apply a rigorous and automated process to identify the identity of a speaker accurately and efficiently. The machine learning system enables recognition and/or identification of tens, hundreds, thousands, or millions of features and/or feature values for tens, hundreds, thousands, or millions of observations, thereby increasing accuracy and consistency and reducing delay associated with the relative resources (e.g., computing or human) required to be allocated for tens, hundreds, or thousands of operators to manually identify customer identities using other means, such as a driver's license or receipt. As indicated above, FIG. 3 is provided as an example. Other examples may differ from what is described in connection with FIG. 3.

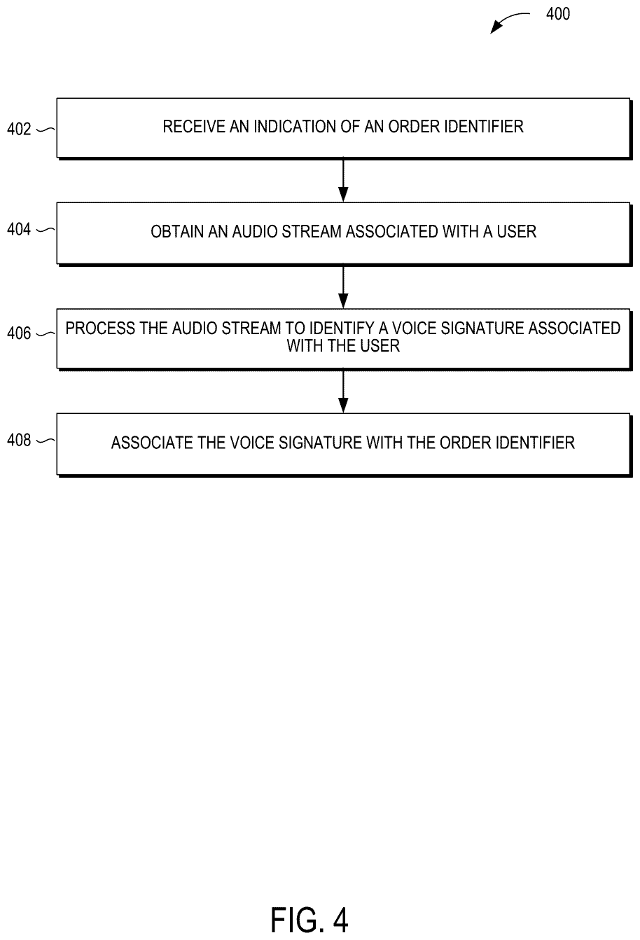

FIG. 4 is a flow diagram illustrative of an embodiment of an automated process 400 for associating a voice signature with an order identifier. Although described as being implemented by the order management system 110, it will be understood that the elements outlined for process 400 can be implemented by one or more computing devices or components that are associated with the order management environment 100, such as, but not limited to, the order processing system 111, the biometrics system 112, the identity verification system 113, the order catalog 116, the client device 120, etc. Thus, the following illustrative embodiment should not be construed as limiting.

At block 402, the order management system 110 receives an order identifier. The order identifier can be received by the order management system 110 from any of a variety of sources, such as from a customer using a mobile order and/or pay software mobile application, from a customer using an online ordering method, from a cashier entering an order identifier locally at a store in response to oral instructions from a customer at an in-store counter or via a drive-thru ordering system, a customer entering an order identifier locally via an in-store self-service kiosk, and/or other source.

At block 404, the order management system 110 obtains an audio stream associated with a user that is assigned to retrieve contents of the order. As mentioned, a customer may place the order and may assign herself or another individual to pick up the contents of the order from the pickup location. As such, the user can be the customer or another individual.

The audio stream may be a new audio stream, recorded by the order management system 110 or an associated system. For example, the order management system 110 may capture, using an audio capturing device (e.g., a microphone), audio of the user providing an audio sample (e.g., speaking). In some cases, the order management system 110 obtains the audio stream using the same source that it used to obtain the order (e.g., via a computing device with access to a microphone, via a mobile application with access to a microphone, via a kiosk with a microphone, etc.)

The audio stream may be a pre-recorded audio stream. For example, the audio stream may have been previously recorded and stored in local memory. In some such cases, the customer or user may upload an audio file included the pre-recorded audio stream to the order management system 110. The customer or user may do this as part of the ordering process, such as when the order is placed. As another example, the audio stream may have been previously recorded associated with the user by the order management system 110. For example, the order management system 110 may have a saved customer profile (e.g., corresponding to a previous order), and the order management system 110 may obtain the audio stream from the customer profile, for example responsive to the order being placed.

In some cases, the audio stream includes an authentication phrase. For example, the audio stream can include an audio sample of the user speaking the authentication phrase. In some cases, the authentication phrase may be provided by the order management system 110. For example, the order management system 110 may generate or select from memory a unique or uncommon authentication phrase for the user to speak. In some cases, the authentication phrase may be selected or created by the user. For example, the user may speak an unplanned phrase or a predetermined. It will be appreciated that the authentication phrase can include a series of one or more words, numbers, letters, sounds, etc., such as a particular number of words or for a particular duration of time. In some cases, the order management system 110 may save and/or output an indication of the authentication phrase. For example, the order management system 110 may provide a receipt for the order to the customer/user and the receipt can include the authentication phrase.

At block 406, the order management system 110 processes the audio stream to identify or create a voice signature associated with the user. The voice signature can include one or more voice characteristics that may be utilized to identify an individual. For example, a voice signature can include a distinctive pattern, frequency, duration, amplitude, volume, picture, or the like. In some cases, a voice signature uniquely identifies the voice of the audio stream from some or all other voices. The order management system 110 may process the audio stream and/or identify or create the voice signature using a machine learning system, as described herein. In addition or alternatively, the order management system 110 may process the audio stream and/or identify or create the voice signature using one or more speaker recognition technologies, such as the Azure Cognitive Service Speaker Recognition service.

At block 408, the order management system 110 associates the voice signature with the order identifier and/or with the user. For example, the order management system 110 may store, in memory (e.g., the order catalog 116) a correlation between an order identifier, a user identifier, and/or an indication of the voice signature. In this way, the order identifier can be linked to the voice signature, such that when a voice sample having the same or a similar voice signature is provided, the order identifier can be determined. For example, during an order pickup period, the order management system 110 can query the order catalog 116 for order identifier field values that correspond to a provided voice sample.

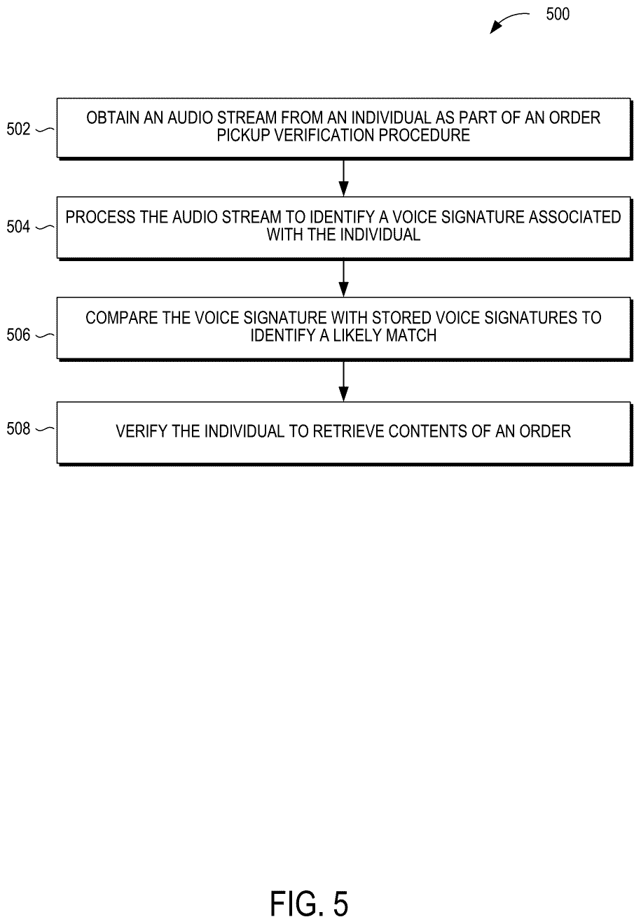

It will be understood that the various blocks described with respect to FIG. 4 can be implemented in a variety of orders and/or can be implemented concurrently or in an altered order, as desired. For example, in some cases, the process 400 can be concurrently performed for multiple order identifiers, such as tens, hundreds, or thousands of order identifiers. Furthermore, it will be understood that fewer, more, or different blocks can be used as part of the process 400 of FIG. 4. For example, the process 400 of FIG. 4 may include one or more steps of the process 500 of FIG. 5.

FIG. 5 is a flow diagram illustrative of an embodiment of an automated process 500 for authenticating an individual for order pickup. Although described as being implemented by the order management system 110, it will be understood that the elements outlined for process 500 can be implemented by one or more computing devices or components that are associated with the order management environment 100, such as, but not limited to, the order processing system 111, the biometrics system 112, the identity verification system 113, the order catalog 116, the client device 120, etc. Thus, the following illustrative embodiment should not be construed as limiting.

At block 502, the order management system 110 obtains an audio stream from an individual. In some cases, the order management system 110 obtains the audio stream as part of an order pickup verification procedure. As described herein (e.g., with respect to FIG. 4), a customer may place an order identifier and may assign or otherwise designate a user to retrieve the contents of the order from a pickup location. As an example, a customer may place an order for a bicycle from a retail store and may designate Person A to retrieve the bicycle from the retail store once the order is ready for pickup.

The order management system 110 may capture the audio stream during an order pickup period. In some cases, the order pickup period may correspond to a time period during which the user is present at a pickup location. In some cases, the order pickup period may correspond to a time period during which the order is ready for pickup.

The audio stream may be a new audio stream, recorded by the order management system 110 or an associated system. For example, the order management system 110 may capture, using an audio capturing device (e.g., a microphone), audio of the user providing an audio sample (e.g., speaking).

In some cases, the order management system 110 obtains the audio stream using an on-site audio capture device (e.g., a microphone at a kiosk). In this way, the order management system 110 can ensure that the person providing the audio sample is the same person that is attempting to pick up an order identifier. In some cases, the order management system 110 obtains the audio stream using the same source that it used to obtain the order identifier (e.g., via a computing device with access to a microphone, via a mobile application with access to a microphone, via a kiosk with a microphone, etc.). In some cases, the audio stream includes an authentication phrase, as described herein. For example, the audio stream can include an audio sample of the user speaking the authentication phrase.

At block 504, similar to block 404 of FIG. 4, the order management system 110 processes the audio stream to identify or create a voice signature associated with the user.

At block 506, the order management system 110 compares the voice signature with stored voice signatures to determine whether the voice signature matches a voice signature corresponding to an order identifier that is ready for pickup. For example, the order management system 110 can query the order catalog 116 for order identifier field values that correspond to a provided voice signature. In some cases, a voice signature matches a stored voice signature if it includes the same authentication phrase. In some cases, a voice signature matches a stored voice signature if it is substantially similar to the stored voice signature. In some cases, a voice signature matches a stored voice signature if it a speaker recognition technology, such as the Azure Cognitive Service Speaker Recognition service, determines that a confidence value associated with a likelihood that the voice signatures match satisfies a confidence threshold. In some cases, the order management system 110 evaluates the voice signature against the stored voice signature to generate a score, where score corresponds to a degree of similarity between the voice signature and the stored voice signature. In some such cases, the order management system 110 can determine that the voice signature matches a stored voice signature based on a determination that the score satisfies a score threshold.

At block 506, the order management system 110 determines whether or not to verify the individual based on the comparison at block 506. In some cases, if the order management system 110 determines that the voice signature matches a store voice signature, then the order management system 110 can authenticate the individual to retrieve an order identifier corresponding to the stored voice signature. In some cases, if the order management system 110 determines that the voice signature does not match any store voice signatures, then the order management system 110 can determined not to authenticate the individual to retrieve an order identifier. In some such cases, the order management system 110 can output an alert to initiate a manual review process to determine whether the individual is authorized to retrieve an order.

It will be understood that the various blocks described with respect to FIG. 5 can be implemented in a variety of orders and/or can be implemented concurrently or in an altered order, as desired. For example, in some cases, the process 500 can be concurrently performed for multiple order identifiers, such as tens, hundreds, or thousands of order identifiers. Furthermore, it will be understood that fewer, more, or different blocks can be used as part of the process 500 of FIG. 5. For example, the process 500 of FIG. 5 may include one or more steps of the process 400 of FIG. 4.

### Example Embodiments

Various examples of methods and systems for authenticating a user for order pickup can be found in the following clauses:

Clause 1. A computer-implemented method for authenticating a user for order pickup, the method comprising:
receiving an indication of an order identifier, wherein the order identifier is associated with contents for purchase by a customer;
obtaining a first audio stream associated with a user, wherein the user is designated by the customer to retrieve the contents of the order from a pickup location;
processing the first audio stream to identify a voice signature associated with the user; and
associating the voice signature with the order identifier,
wherein the user is verified to retrieve the order identifier based on a second audio stream provided by an individual during an order pickup period.

Clause 2. The method of clause 1, further comprising: obtaining the second audio stream as part of an order pickup verification procedure, wherein the second audio stream corresponds to a phrase spoken by the individual during the order pickup period;
processing the second audio stream to identify a voice signature associated with the individual;
comparing the voice signature with the voice signature associated with the user;
determining that the individual is the user based on the comparing; and
verifying the individual to retrieve contents of the order based on the determining.

Clause 3. The method of any of the preceding clauses, wherein the first audio stream comprises an authentication phrase, and wherein the user is verified based on a determination that the second audio stream comprises the authentication phrase.

Clause 4. The method of clause 3, wherein the authentication phrase is selected by the customer or the user.

Clause 5. The method of clause 3, further comprising: generating the authentication phrase; and
outputting an indication of the authentication phrase responsive to the indication of the order.

Clause 6. The method of any of the preceding clauses, further comprising:
obtaining the second audio stream during the order pickup period; and
evaluating the second audio stream to generate a score, wherein the score corresponds to a confidence that the second audio stream was spoken by the user.

Clause 7. The method of clause 6, further comprising verifying the user to retrieve the contents of the order based on a determination that the score satisfies a score threshold.

Clause 8. The method of any of the preceding clauses, wherein the voice signature is a first voice signature, wherein the method further comprises:
obtaining the second audio stream during the order pickup period;
processing the second audio stream to identify a second voice signature; and
evaluating the second voice signature against the first voice signature to generate a score, wherein the score corresponds to a degree of similarity between the first voice signature and the second voice signature,
wherein the user is verified to retrieve the contents of the order based on a determination that the score satisfies a first score threshold, and wherein the user is not verified to retrieve the contents of the order based on a determination that the score does not satisfy a second score threshold.

Clause 9. The method of any of the preceding clauses, further comprising:
obtaining a third audio stream during the order pickup period, wherein the third audio stream was spoken by an individual;
evaluating the third audio stream to generate a score, wherein the score corresponds to a confidence that the third audio stream was spoken by the user; and
determining not to verify the individual to retrieve the contents of the order based on a determination that the score does not satisfy a score threshold.

Clause 10. The method of any of the preceding clauses, further comprising:
obtaining a third audio stream during the order pickup period, wherein the third audio stream was spoken by an individual;
evaluating the third audio stream to generate a score, wherein the score corresponds to a confidence that the third audio stream was spoken by the user; and
determining not to verify the individual to retrieve the contents of the order based on a determination that the score does not satisfy a score threshold.

Clause 11. The method of any of the preceding clauses, wherein the processing the first audio stream comprising generating a voiceprint of the user, wherein the voiceprint of the user comprises a distinctive pattern of voice signatures of the user, wherein the user is verified to retrieve the order identifier based on a determination that the second audio stream is associated with a same voiceprint as the first audio stream.

Clause 12. The method of any of the preceding clauses, wherein the voice signature is a first voice signature, wherein the method further comprises:
obtaining a third audio stream during the order pickup period, wherein the third audio stream was spoken by an individual;
processing the third audio stream to identify a second voice signature associated with the individual; and
comparing the second voice signature with stored voice signatures to determine whether the second voice signature correspond to any of the stored voice signatures, wherein each voice signature of the stored voice signatures is associated with a particular order identifier of a plurality of order identifiers.

Clause 13. The method of clause 11, further comprising:
based on the comparing, determining that that the second voice signature corresponds to a first stored voice signature; and
verifying the individual to retrieve contents of an order that is associated with the first stored voice signature.

Clause 14. The method of clause 11, further comprising:
based on the comparing, determining that that the second voice signature does not correspond to any of the stored voice signatures; and
determining not to verify the individual to retrieve contents of any order identifiers.

Clause 15. A system, comprising:
one or more processors communicatively coupled to a display, the one or more processors configured to:
receive an indication of an order identifier, wherein the order identifier is associated with contents for purchase by a customer;
obtain a first audio stream associated with a user, wherein the user is designated by the customer to retrieve the contents of the order from a pickup location;
process the first audio stream to identify a voice signature associated with the user; and
associate the voice signature with the order identifier,
wherein the user is verified to retrieve the order identifier based on a second audio stream provided by the user during an order pickup period.

Clause 16. The system of clause 15, wherein the voice signature is a first voice signature, wherein the one or more processors are further configured to:
obtain the second audio stream during the order pickup period;
process the second audio stream to identify a second voice signature; and
evaluate the second voice signature against the first voice signature to generate a score, wherein the score corresponds to a degree of similarity between the first voice signature and the second voice signature,
wherein the user is verified to retrieve the contents of the order based on a determination that the score satisfies a first score threshold, and wherein the user is not verified to retrieve the contents of the order based on a determination that the score does not satisfy a second score threshold.

Clause 17. The system of any of clauses 15 or 16, wherein the voice signature is a first voice signature, wherein the one or more processors are further configured to:
store an indication of an association of the first voice signature and the order identifier;
determine that that the second voice signature corresponds to the stored first voice signature; and
verify the user to retrieve the contents of the order based on the determination that that the second voice signature corresponds to the stored first voice signature.

Clause 18. Non-transitory computer-readable media storing computer executable instructions that when executed by one or more processors cause the one or more processors to:
receive an indication of an order identifier, wherein the order identifier is associated with contents for purchase by a customer;
obtain a first audio stream associated with a user, wherein the user is designated by the customer to retrieve the contents of the order from a pickup location;
process the first audio stream to identify a voice signature associated with the user; and
associate the voice signature with the order identifier,
wherein the user is verified to retrieve the order identifier based on a second audio stream provided by the user during an order pickup period.

Clause 19. The non-transitory computer-readable media of clause 18, wherein the first audio stream comprises an authentication phrase, and wherein the user is verified based on a determination that the second audio stream comprises the authentication phrase.

Clause 20. The non-transitory computer-readable media of any of clauses 18 or 19, wherein the authentication phrase is selected by the customer or the user.

Clause 21. A computer-implemented method for authenticating a user for order pickup, the method comprising:
obtaining an audio stream as part of an order pickup verification procedure, wherein the audio stream corresponds to a phrase spoken by an individual during an order pickup period;
processing the audio stream to identify a voice signature associated with the individual;
comparing the voice signature with stored voice signatures to identify a first stored voice signature of the stored voice signatures that corresponds to the voice signature associated with the audio stream, wherein each stored voice signature of the stored voice signatures is associated with a respective order identifier of a plurality of order identifiers;
identifying a first order identifier that corresponds to the first stored voice signature; and
verifying the individual to retrieve contents of the first order identifier.

Clause 22. The method of clause 21, wherein the audio stream comprises an authentication phrase, and wherein the individual is verified based on a determination that the authentication phrase matches an expected authentication phrase.

Clause 23. The method of clause 22, wherein the expected authentication phrase is selected by a customer during placement of the first order identifier.

Clause 24. The method of clause 22, further comprising:
evaluating the voice signature against the stored voice signature to generate a score, wherein the score corresponds to a degree in which the voice signature matches the stored voice signature.

Clause 25. The method of clause 24, wherein the verifying is further based on a determination that the score satisfies a score threshold.

Clause 26. The method of clause 22, wherein the audio stream is a first audio stream, wherein the voice signature is a first voice signature, wherein the individual is a first individual, wherein the method further comprises:
obtaining a second audio stream from a second individual as part of the order pickup verification procedure;
processing the second audio stream to identify a second voice signature;
comparing the second voice signature with the stored voice signatures;
determining not to verify the individual to retrieve contents of any order identifiers based on a determination that the second voice signature does not correspond to any of the stored voice signatures.

Clause 27. The method of clause 22, wherein the processing the audio stream comprising generating a voiceprint for the individual, wherein the voiceprint comprises a distinctive pattern of voice signatures of the individual.

Clause 28. A system, comprising:
one or more processors communicatively coupled to a display, the one or more processors configured to:
obtain an audio stream as part of an order pickup verification procedure, wherein the audio stream corresponds to a phrase spoken by an individual during an order pickup period;
process the audio stream to identify a voice signature associated with the individual;
compare the voice signature with stored voice signatures to identify a first stored voice signature of the stored voice signatures that corresponds to the voice signature associated with the audio stream, wherein each stored voice signature of the stored voice signatures is associated with a respective order identifier of a plurality of order identifiers;
identify a first order identifier that corresponds to the first stored voice signature; and
verify the individual to retrieve contents of the first order identifier.

Clause 29. The system of clause 28, wherein the one or more processors are configured to perform any of the steps or have any of the features described in any of the preceding claims.

Clause 30. Non-transitory computer-readable media storing computer executable instructions that when executed by one or more processors cause the one or more processors to:
obtain an audio stream as part of an order pickup verification procedure, wherein the audio stream corresponds to a phrase spoken by an individual during an order pickup period;
process the audio stream to identify a voice signature associated with the individual;
compare the voice signature with stored voice signatures to identify a first stored voice signature of the stored voice signatures that corresponds to the voice signature associated with the audio stream, wherein each stored voice signature of the stored voice signatures is associated with a respective order identifier of a plurality of order identifiers;
identify a first order identifier that corresponds to the first stored voice signature; and
verify the individual to retrieve contents of the first order identifier.

Clause 31. The non-transitory computer-readable media of claim 20, wherein the computer executable instructions, when executed by one or more processors. cause the one or more processors to perform any of the steps or have any of the features described in any of the preceding claims.

### Terminology

Conditional language, such as, among others, “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Unless the context clearly requires otherwise, throughout the description and the claims, the words “include,” “can include,” and the like are to be construed in an inclusive sense, as opposed to an exclusive or exhaustive sense; that is to say, in the sense of “including, but not limited to.” Additionally, the words “herein,” “above,” “below,” and words of similar import, when used in this application, refer to this application as a whole and not to any particular portions of this application. Where the context permits, words in the above Detailed Description using the singular or plural number may also include the plural or singular number, respectively. The word “or” in reference to a list of two or more items, covers all of the following interpretations of the word: any one of the items in the list, all of the items in the list, and any combination of the items in the list. Likewise the term “and/or” in reference to a list of two or more items, covers all of the following interpretations of the word: any one of the items in the list, all of the items in the list, and any combination of the items in the list.

Depending on the embodiment, certain operations, acts, events, or functions of any of the routines described elsewhere herein can be performed in a different sequence, can be added, merged, or left out altogether (non-limiting example: not all are necessary for the practice of the algorithms). Moreover, in certain embodiments, operations, acts, functions, or events can be performed concurrently, rather than sequentially.

Some implementations are described herein in connection with thresholds. As used herein, satisfying a threshold may, depending on the context, refer to a value being greater than the threshold, more than the threshold, higher than the threshold, greater than or equal to the threshold, less than the threshold, fewer than the threshold, lower than the threshold, less than or equal to the threshold, equal to the threshold, etc., depending on the context.

As used herein, the term “component” is intended to be broadly construed as hardware, firmware, or a combination of hardware and software.

These and other changes can be made to the present disclosure in light of the above Detailed Description. While the above description describes certain examples of the present disclosure, and describes the best mode contemplated, no matter how detailed the above appears in text, the present disclosure can be practiced in many ways. Details of the system may vary considerably in its specific implementation, while still being encompassed by the present disclosure disclosed herein. As noted above, particular terminology used when describing certain features or aspects of the present disclosure should not be taken to imply that the terminology is being redefined herein to be restricted to any specific characteristics, features, or aspects of the present disclosure with which that terminology is associated. In general, the terms used in the following claims should not be construed to limit the present disclosure to the specific examples disclosed in the specification, unless the above Detailed Description section explicitly defines such terms. Accordingly, the actual scope of the present disclosure encompasses not only the disclosed examples, but also all equivalent ways of practicing or implementing the present disclosure under the claims.

Disjunctive language such as the phrase “at least one of X, Y, or Z,” unless specifically stated otherwise, is otherwise understood with the context as used in general to present that an item, term, etc., may be either X, Y, or Z, or any combination thereof (non-limiting examples: X, Y, and/or Z). Thus, such disjunctive language is not generally intended to, and should not, imply that certain embodiments require at least one of X, at least one of Y, or at least one of Z to each be present.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described elsewhere herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

Any terms generally associated with circles, such as “radius” or “radial” or “diameter” or “circumference” or “circumferential” or any derivatives or similar types of terms are intended to be used to designate any corresponding structure in any type of geometry, not just circular structures. For example, “radial” as applied to another geometric structure should be understood to refer to a direction or distance between a location corresponding to a general geometric center of such structure to a perimeter of such structure; “diameter” as applied to another geometric structure should be understood to refer to a cross sectional width of such structure; and “circumference” as applied to another geometric structure should be understood to refer to a perimeter region. Nothing in this specification or drawings should be interpreted to limit these terms to only circles or circular structures.

What is claimed is:

1. A method comprising:
receiving an indication of an order identifier, wherein the order identifier is associated with contents in a point-of-sale (POS) transaction;
obtaining a first audio stream associated with a user;
processing the first audio stream to identify a voice signature associated with the user;
associating the voice signature with the order identifier, wherein a POS computing device authenticates the user during an order pickup period based on a second audio stream provided by the user during an order pickup period.

2. The method of claim 1, further comprising:
obtaining the second audio stream as part of an order pickup verification procedure, wherein the second audio stream corresponds to a phrase spoken by the user during the order pickup period;
processing the second audio stream to identify a voice signature associated with the user;
comparing the voice signature with the voice signature associated with the user; and
verifying the user to retrieve contents of the order based on the comparing.

3. The method of claim 2, wherein the first audio stream comprises an authentication phrase, and wherein the user is verified based on a determination that the second audio stream comprises the authentication phrase.

4. The method of claim 3, wherein the authentication phrase is selected by the user.

5. The method of claim 3, further comprising:
generating the authentication phrase; and
outputting an indication of the authentication phrase responsive to the indication of the order identifier.

6. The method of claim 1, further comprising:
obtaining the second audio stream during the order pickup period; and
evaluating the second audio stream to generate a score, wherein the score corresponds to a confidence that an individual that spoke the second audio stream is a same person as the user that spoke the first audio stream.

7. The method of claim 6, further comprising verifying the user to retrieve the contents based on a determination that the score satisfies a score threshold.

8. The method of claim 1, wherein the voice signature is a first voice signature, wherein the method further comprises:
obtaining the second audio stream during the order pickup period;
processing the second audio stream to identify a second voice signature; and
evaluating the second voice signature against the first voice signature to generate a score, wherein the score corresponds to a degree of similarity between the first voice signature and the second voice signature,
wherein the user is verified to retrieve the contents of the order based on a determination that the score satisfies a first score threshold, and wherein the user is not verified to retrieve the contents of the order based on a determination that the score does not satisfy a second score threshold.

9. The method of claim 1, further comprising:
obtaining a third audio stream during the order pickup period, wherein the third audio stream was spoken by an individual;
evaluating the third audio stream to generate a score, wherein the score corresponds to a confidence that the third audio stream was spoken by the user; and
determining not to verify the individual to retrieve the contents of the order based on a determination that the score does not satisfy a score threshold.

10. The method of claim 1, wherein the processing the first audio stream comprising generating a voiceprint of the user, wherein the voiceprint of the user comprises a distinctive pattern of voice signatures of the user, wherein the user is verified to retrieve the order identifier based on a determination that the second audio stream is associated with a same voiceprint as the first audio stream.

11. The method of claim 1, wherein the voice signature is a first voice signature, wherein the method further comprises:
obtaining a third audio stream during the order pickup period, wherein the third audio stream was spoken by an user;
processing the third audio stream to identify a second voice signature associated with the user; and
comparing the second voice signature with stored voice signatures to determine whether the second voice signature correspond to any of the stored voice signatures, wherein each voice signature of the stored voice signatures is associated with a particular order identifier of a plurality of order identifiers.

12. The method of claim 11, further comprising:
based on the comparing, determining that that the second voice signature corresponds to a first stored voice signature; and
verifying the user to retrieve the contents.

13. The method of claim 11, further comprising:
based on the comparing, determining that that the second voice signature does not correspond to any of the stored voice signatures; and
determining not to verify the user to retrieve contents of any order identifiers.

14. The method of claim 1, wherein said obtaining the first audio stream comprises obtaining the first audio stream at a user POS computing device that is different from the POS computing device, wherein the POS computing device is located proximate a retail location storing the contents of the POS transaction.

15. A system, comprising:
one or more processors communicatively coupled to a display, the one or more processors configured to:
receive an indication of an order identifier, wherein the order identifier is associated with contents in a point-of-sale (POS) transaction;
obtain a first audio stream associated with a user;
process the first audio stream to identify a voice signature associated with the user; and
associate the voice signature with the order identifier, wherein a POS computing device authenticates the user during an order pickup period based on a second audio stream provided by the user during an order pickup period.

16. The system of claim 15, wherein the voice signature is a first voice signature, wherein the one or more processors are further configured to:
obtain the second audio stream during the order pickup period;
process the second audio stream to identify a second voice signature; and
evaluate the second voice signature against the first voice signature to generate a score, wherein the score corresponds to a degree of similarity between the first voice signature and the second voice signature,
wherein the user is verified to retrieve the contents of the order based on a determination that the score satisfies a first score threshold, and wherein the user is not verified to retrieve the contents of the order based on a determination that the score does not satisfy a second score threshold.

17. The system of claim 16, wherein the voice signature is a first voice signature, wherein the one or more processors are further configured to:
store an indication of an association of the first voice signature and the order identifier;
determine that that the second voice signature corresponds to the first voice signature; and
verify the user to retrieve the contents of the order based on the determination that that the second voice signature corresponds to the stored first voice signature.

18. Non-transitory computer-readable media storing computer executable instructions that when executed by one or more processors cause the one or more processors to:
receive an indication of an order identifier, wherein the order identifier is associated with contents in a point-of-sale (POS) transaction;
obtain a first audio stream associated with a user;
process the first audio stream to identify a voice signature associated with the user; and
associate the voice signature with the order identifier, wherein a POS computing device authenticates the user during an order pickup period based on a second audio stream provided by the user during an order pickup period.

19. The non-transitory computer-readable media of claim 18, wherein the first audio stream comprises an authentication phrase, and wherein the user is verified based on a determination that the second audio stream comprises the authentication phrase.

20. The non-transitory computer-readable media of claim 19, wherein the authentication phrase is selected by the user.
